(19) United States
(12) Patent Application Publication
(10) Pub. No.: US 2014/0054400 A1
(43) Pub. Date: Feb. 27, 2014

(54) Device For Dispensing Liquid Product Provided With A Flow Reduction Member

(71) Applicants: Jose Camba, Amberieu En Bugey (FR); Philippe Pagny, Ambronay (FR); Pascal Dugand, Estrablin (FR)

(72) Inventors: Jose Camba, Amberieu En Bugey (FR); Philippe Pagny, Ambronay (FR); Pascal Dugand, Estrablin (FR)

(21) Appl. No.: 14/113,150

(22) PCT Filed: Apr. 18, 2012
(86) PCT No.: PCT/FR2012/050848

§ 371 Date: Oct. 21, 2013

(30) Foreign Application Priority Data
Apr. 21, 2011 (FR) 1153488

(51) Int. Cl. B05B 1/30

(52) U.S. Cl. CPC B05B 1/30
USPC 239/590

(57) ABSTRACT

A liquid dispenser device that includes: a dispenser endpiece including a cavity having an end wall from which there extends a longitudinal liquid outlet channel; and a flow reducer member that is fitted in the cavity of the endpiece, the flow reducer member including a transverse surface that co-operates with the end wall of the endpiece to define a liquid deflector channel that extends in a transverse plane, the deflector channel being non-rectilinear.

### FIELD OF THE INVENTION

The present invention relates to a dispenser endpiece for dispensing liquid, in particular in the pharmaceutical field, such as a liquid for the ears, the mouth, or the eyes.

The term “liquid” is used to designate a substance that is non-solid and non-gaseous. It should be understood that the substance may be liquid to a greater or lesser extent, depending on its viscosity. The term “liquid” also includes a paste or semi-liquid substance.

### BACKGROUND OF THE INVENTION

Document WO 2004/069679 discloses a dispenser endpiece for dispensing liquid, which endpiece is fitted on a reservoir having a deformable wall. The dispenser endpiece includes a longitudinal liquid outlet channel, and an insert that co-operates with a wall of the endpiece to define an essentially longitudinal flow limiter channel.

However, the endpiece may be voluminous, particularly when the liquid has low viscosity, since, in order to increase the head loss created within the liquid, it is thus necessary to increase the length of the flow limiter channel and thus increase the longitudinal size of the insert.

Another solution may be to increase the length of the channel and/or to reduce the section of the flow limiter channel. However, in mass production, it is particularly difficult to make flow limiter channels of small flow section, specifically when the channels are long.

### OBJECTS AND SUMMARY OF THE INVENTION

An object of the present invention is to provide a dispenser device that is compact and simple to make.

For this purpose, the invention provides in particular a liquid dispenser device comprising:

a dispenser endpiece including a cavity having an end wall from which there extends a longitudinal liquid outlet channel; and

a flow reducer member that is fitted in the cavity of the endpiece, said flow reducer member including a transverse surface that co-operates with the end wall of the endpiece to define a liquid deflector channel that extends in a transverse plane, the deflector channel being non-rectilinear.

The term “non-rectilinear channel” means a channel that presents a path that makes it possible to increase the head losses within the liquid either by increasing the length of the channel or by creating local disruptions in the flow of the liquid (such as a sudden change in flow direction, or a sudden change in channel section).

Thus, the channel may be curved, and may, for example, be in the shape of a spiral. Alternatively, the channel may include a plurality of consecutive segments that are not aligned, i.e. two consecutive segments that form between them an angle that is different from 180°, preferably lying in the range 10° to 90°.

It should be noted that the longitudinal liquid outlet channel generally opens out directly into the liquid outlet orifice formed on the endpiece.

It should also be noted that the liquid deflector channel extends in a transverse plane, i.e. the generator line of the channel is situated in a transverse plane. By way of example, the channel differs from a helical channel.

However, it should be understood that in addition to the above-defined deflector channel, the device may include other flow limiter channels, such as a helical channel, a channel having a constricted section, etc.

A simple and compact liquid dispenser device is thus obtained for controlling the dispensing of liquid. Since the liquid deflector channel is provided in a transverse plane, it is possible to provide a flow reducer member of size that is small in the longitudinal direction. More precisely, the shape of the deflector channel is modified in the transverse plane in such a manner as to create the desired head losses without necessarily having to increase the height of the flow reducer member in the longitudinal direction.

It should be understood that it is possible to create head losses within the liquid either by modifying the section and/or the length of the deflector channel or by generating local disruptions in the flow of the liquid.

As a result of the member being fitted inside the endpiece, it is easy and inexpensive to modify the flow parameters of the liquid. By modifying only the flow reducer member or the end wall of the endpiece, it is possible to modify the flow deflector channel so as to define a channel of section that is different, of length that is different, and/or of shape that is different.

While dispensing liquid in the form of drops, corresponding to the preferred dispensing method, it is thus possible to match the liquid deflector channel to the viscosity of the liquid to be dispensed and/or to the size of the drops that it is desired to deliver.

The device is particularly advantageous for better control over the size of the drops that are delivered, i.e. the quantity of medication that is delivered, by making it possible to overcome external parameters that intervene during the delivery of a drop of liquid, such as the stiffness of the reservoir, surface states, the force and the speed with which the user squeezes the walls of the reservoir, or possible tremors of the user. Thus, for a given reservoir and a liquid of known viscosity, it is possible to determine the shape of the liquid deflector channel that makes it possible to ensure that the quantity of liquid delivered each time the user applies pressure is reproducible.

The device may further comprise one or more of the following characteristics.

The end wall of the endpiece includes a transverse surface that is substantially plane, and the transverse surface of the flow reducer member includes portions in relief that co-operate with the end wall of the endpiece to define the liquid deflector channel. It is thus possible to modify the portions in relief of the transverse surface of the member so as to co-operate with the transverse surface of the endpiece to define a channel of section that is different, of length that is different, and/or of shape that is different. It is thus possible to use an endpiece of shape that is standard, and to adapt only the reducer member as a function of the type of liquid that is to be dispensed.

The flow reducer member includes a base having a support function, carrying the portions in relief, and having a height in the longitudinal direction that is greater than the height of the portions in relief. The large thickness of the base makes it possible to ensure that the portions in relief are pressed against the transverse surface of the endpiece. Thus, this member has a certain amount of stiffness, and sealing between the member and the transverse surface of the endpiece is guaranteed. It should thus be understood that the flow reducer member is non-porous, i.e. the liquid cannot pass through the walls of the member. Consequently, the liquid is compelled to follow along the entire length of the liquid deflector channel, i.e. the pressure of the liquid cannot deform the member and thus the channel in such a manner as to short circuit a fraction of the deflector channel.

The transverse surface of the flow reducer member is substantially plane, and the end wall of the endpiece includes portions in relief that co-operate with the transverse surface of the flow reducer member to define the liquid deflector channel. It is thus possible to modify the portions in relief of the end wall of the endpiece so as to co-operate with the transverse surface of the member to define a channel of section that is different, of length that is different, and/or of shape that is different. It is thus possible to use a flow reducer member of shape that is simple.

The flow reducer member is in the general shape of a disk. By way of example, it is defined by two plane transverse surfaces and an annular peripheral surface, while having a liquid flow channel pass therethrough.

The height of the portions in relief in the longitudinal direction is less than 0.6 millimeters (mm) and preferably lies in the range 0.05 mm to 0.5 mm.

The height of the base in the longitudinal direction is greater than 0.6 mm and preferably lies in the range 1 mm to 1.5 mm.

The flow reducer member includes an essentially longitudinal “feed channel” through which liquid flows, and the liquid deflector channel forms a junction between the outlet channel and the feed channel. This feed channel makes it possible to convey the liquid from the reservoir to the liquid deflection channel.

The feed channel is defined entirely by the flow reducer member. Thus, by being defined entirely by one part, its dimensions are easier to control than when it is defined by two parts together, which could be the situation when the channel is defined both by an annular surface of the flow reducer member and also by an annular surface of the endpiece. The annular sealing between the annular wall of the endpiece and the annular wall of the flow reducer member is thus easier to guarantee, and the feed channel has a section that is less subject to manufacturing tolerances. However, it should be understood that the feed channel may alternatively be arranged on the periphery of the member, being defined by an annular surface of the endpiece.

The flow reducer member is pressed against the transverse surface of the endpiece in the longitudinal direction, e.g. being fastened by snap-fastening, by clamping, or by ultrasonic welding. The member is thus pushed against the end wall of the endpiece in the longitudinal direction, and the portions in relief are pressed, and preferably flattened a little, against the end wall of the endpiece or of the flow reducer member, thereby guaranteeing, in still more reliable manner, the sealing between the portions in relief of the member or of the endpiece and the end wall of the endpiece or of the flow reducer member respectively. This thus ensures that the liquid follows along the entire length of the liquid deflection channel.

The device comprises only two parts: the dispenser endpiece and the flow reducer member. The device is thus very simple to make.

The flow reducer member includes a closure wall for closing the outlet channel, which closure wall is elastically movable between a rest configuration in which liquid can pass, and a deformed configuration in which the wall is pressed against the outlet channel so as to close it. Thus, if the user presses too suddenly and/or too hard on the reservoir so as to dispense the liquid, the sudden increase in the pressure of the liquid in the reservoir forces the closure wall into its deformed configuration against the outlet channel and closes it, at least in part. It is thus not possible for a jet of liquid to be formed there. In contrast, during normal use of the device, the balance of the pressures of the liquid on either side of the flow reducer member prevents the closure wall from taking up its deformed configuration, and the liquid can pass from the liquid deflector channel to the liquid outlet channel. The outlet channel may of course be closed completely.

The closure wall is connected to a base of the flow reducer member via a deformable wall, the deformable wall presenting a thickness that is small relative to the thickness of the base. The small thickness of the deformable wall enables the closure wall to move between the rest and deformed configurations, while enabling the flow reducer member to be made as a single piece.

The device is fitted on a reservoir, and the dispenser endpiece is mounted in leaktight manner on the reservoir.

The endpiece is molded as a single piece.

The flow reducer member is molded as a single piece.

The flow reducer member is made out of a flexible material, e.g. an elastomer material. Thus, the reducer member advantageously adapts to any dimensional clearances and/or surface irregularities that might be present, thereby making it possible to improve the sealing between the flow reducer member and the endpiece.

### BRIEF DESCRIPTION OF THE DRAWINGS

The invention can be better understood on reading the following description given merely by way of example, and with reference to the drawings, in which:

FIG. 1 is a diagrammatic longitudinal section view of a dispenser device in a first embodiment, the device being fitted on a reservoir and covered by a cap;

FIGS. 2A and 2B are diagrammatic perspective and top views respectively of the flow reducer member of the FIG. 1 embodiment;

FIG. 3 is a diagrammatic longitudinal section view of a dispenser device in a second embodiment;

FIGS. 4A and 4B are diagrammatic perspective and top views respectively of the flow reducer member of the FIG. 3 embodiment;

FIG. 5 is a diagrammatic representation of a flow reducer member of a device in a third embodiment;

FIG. 6 is a diagrammatic longitudinal section view of a device in a fourth embodiment; and

FIG. 7 is a diagrammatic perspective view of the flow reducer member of the FIG. 6 embodiment.

### MORE DETAILED DESCRIPTION

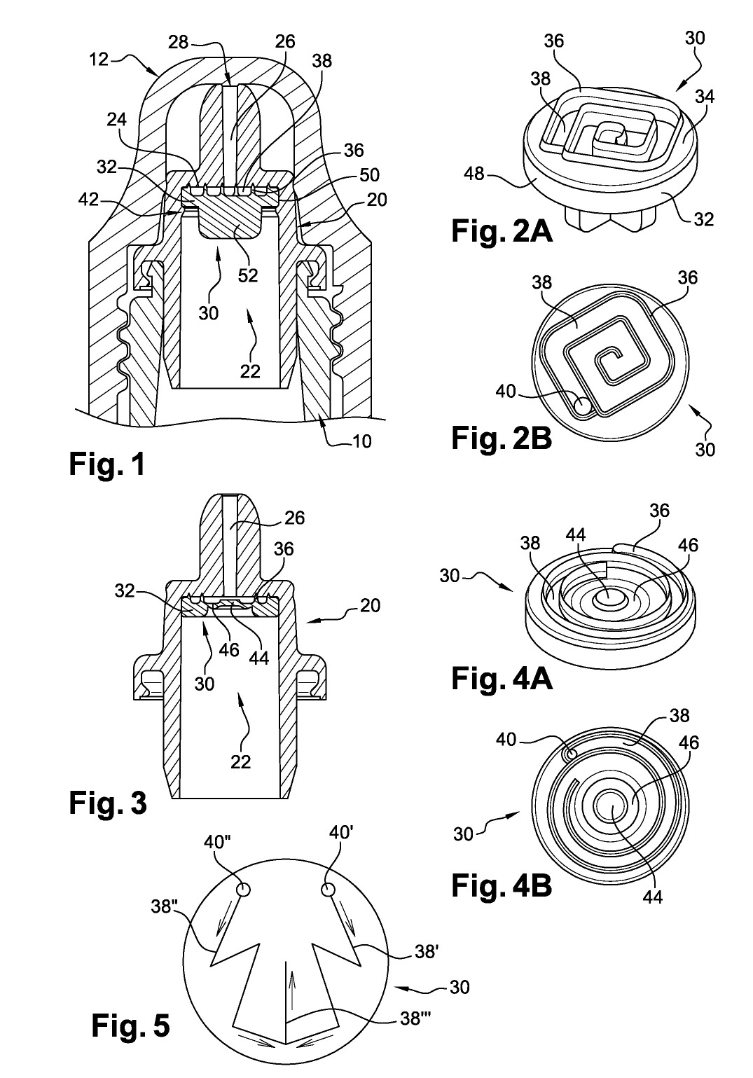

FIG. 1 shows the top portion of the neck 10 of a reservoir containing liquid to be dispensed. In this embodiment, the liquid is a pharmaceutical liquid such as liquid for the eyes, the mouth, or the ears, which liquid may contain preservatives.

A liquid dispenser device is fitted in leaktight manner on the neck 10 of the reservoir, by snap-fastening in this embodiment. The device includes a dispenser endpiece 20 and, as shown in FIG. 1, it may be covered by a cap 12 that is screw-fastened on the neck 10 of the reservoir.

The endpiece 20 includes a cavity 22 that is defined both by an end wall 24 having a substantially plane transverse surface, and also by an annular skirt that is inserted inside the neck 10 of the reservoir. The cavity 22 is of shape that is substantially cylindrical. The transverse surface has a longitudinal liquid outlet channel 26 passing therethrough. The outlet channel 26 forms a liquid dispenser nozzle via which the liquid is delivered in the form of drops. At its upstream end, the channel 26 opens out in the end wall 24 of the endpiece, and at its downstream end, it leads to a liquid dispenser orifice 28 that often includes means for forming drops, e.g. by being flared. Preferably, the endpiece 20 is molded as a single piece, e.g. made of polypropylene, polyethylene, or an elastomer material.

It should be understood that the longitudinal direction is defined as the direction of the outlet channel 26, and that the transverse direction is perpendicular thereto. References to “upstream” and “downstream” are made relative to the direction of flow of the liquid from the reservoir to the dispenser orifice 28.

In addition to the endpiece 20, the liquid dispenser device also comprises a flow reducer member 30 having the general shape of a disk. The member 30 is fitted in the cavity 22 of the endpiece 20. In this embodiment, it should be observed that the device comprises only two parts: the dispenser endpiece 20 and the flow reducer member 30.

The member 30 comprises a base 32 having a downstream transverse surface 34 that includes portions in relief 36. The portions in relief 36 are molded integrally with the base 32. The base 32 has a support function and carries the portions in relief 36. It also makes it possible to stiffen the member 30.

In this embodiment, the height of the base 32 in the longitudinal direction is greater than the height of the portions in relief 36. For example, the height of the portions in relief is less than 0.6 mm, preferably lying in the range 0.05 mm to 0.5 mm, and the height of the base is greater than 0.6 mm, preferably lying in the range 1 mm to 1.5 mm.

The member 30 also includes a longitudinal “feed channel” 40 through which liquid flows and visible in FIG. 2B. The feed channel 40 passes right through the flow reducer member 30. It enables the liquid contained in the reservoir to pass through the member 30 so as to reach the transverse surface 34 of the endpiece. It should be observed that the feed channel 40 is defined entirely by the flow reducer member 30. In particular, the feed channel 40 is not carried by an annular surface 48 of the flow reducer member 30, and is thus not defined in part by an annular surface 50 of the endpiece. It is thus easier to guarantee both the size of the channel 40 and also annular sealing between the annular wall 50 of the endpiece 20 and the annular wall 48 of the flow reducer member 30.

However, the feed channel 40 could be defined by the annular surfaces 48 and 50 of the flow reducer member and of the endpiece.

Preferably, the member 30 is molded as a single piece, e.g. made of polypropylene, polyethylene, or an elastomer material.

In the embodiment shown in FIG. 1, the endpiece 20 includes a circular bead 42 that makes it possible to press the member 30 against the end wall 24 of the endpiece, and to fasten the member 30 in this position by snap-fastening. Thus, the portions in relief 36 are pressed against the transverse surface of the end wall 24 of the endpiece and, in this embodiment, they are deformed a little by compression so as to guarantee sealing. The portions in relief 36 co-operate with the end wall 24 to define a liquid deflector channel 38. The liquid deflector channel 38 forms a junction between the feed channel 40 and the outlet channel 26.

As can be seen in the various figures, the channel 38 extends in a transverse plane, i.e. the generator line of the channel 38 is situated in a transverse plane.

The liquid deflector channel 38 shown in FIGS. 2A and 2B is not rectilinear, i.e. the path that the liquid must follow in order to go from the feed channel 40 to the outlet channel 26 is not straight. While remaining in a transverse plane, the channel 38 has the general shape of a “square” spiral. Thus, the channel 38 is formed by a succession of segments.

While the member 30 is being pressed against the transverse surface 24 of the endpiece, the stiffness imparted by the base 32 guarantees that the portions in relief 36 come into leaktight contact with the end wall 24, and that the liquid is compelled to flow along the entire length of the liquid deflector channel 38 between the feed channel 40 and the outlet channel 26. It can be seen that the base 32 may also include reinforcement 52 in its central portion, which reinforcement is molded integrally with the member 30. In the present embodiment, the reinforcement 52 has the general shape of a cross so as to limit the amount of additional material that needs to be molded, while guaranteeing that the member has very good stiffness.

In a second embodiment presented in FIGS. 3, 4A, and 4B, the channel 38 may be formed by a circular spiral.

In this embodiment, the flow reducer member 30 also includes a closure wall 44 for closing the outlet channel 26. The closure wall 44 is essentially disk-shaped and is connected to the base 32 of the member 30 via a deformable wall 46 that corresponds to a constriction in thickness. The deformable wall 46 has the shape of a ring and presents thickness that is small relative to the thickness of the base 32, i.e. relative to the height in the longitudinal direction of the base 32. All of the parts of the member 30 are molded integrally with one another so the member 30 can be molded as a single piece.

By means of the deformable wall 46, the closure wall 44 is movable between a rest configuration in which the liquid can pass from the liquid deflector channel 38 to the outlet channel 26, and a deformed configuration in which the closure wall 44 is pressed against the outlet channel 26 so as to close it completely or in part.

Thus, if the user presses too suddenly and/or too hard on the reservoir so as to dispense the liquid, the sudden increase in the pressure of the liquid in the reservoir forces the closure wall 44 into its deformed configuration against the outlet channel 26 and closes it, at least in part. It is thus not possible for a jet of liquid to be formed there.

During normal use of the device, the balance of the pressures of the liquid on either side of the flow reducer member 30 keeps the closure wall 44 in its non-deformed or slightly-deformed configuration, and the liquid can pass from the liquid deflector channel 38 to the liquid outlet channel 26.

It should be observed that in FIG. 3 the base 32 of the flow reducer member 30 is of annular shape, more precisely of toroidal shape. As in the above embodiment, the base 32 that carries the portions in relief 36 has a height in the longitudinal direction that is greater than the height of the portions in relief 36 in the same direction. It is thus guaranteed that the portions in relief 36 are suitably pressed against the end wall 24 of the endpiece 20. Furthermore, in this embodiment, the flow reducer member 30 is fastened on the endpiece 20 by ultrasonic welding. However, any other method of fastening, such as snap-fastening or clamping, may be envisaged.

FIG. 5 shows a third embodiment of the flow reducer member 30. The member includes two feed channels 40′ and 40″, and two liquid deflector channels 38′ and 38″′. The two channels have a common segment 38″′. Thus, each channel 38′ and 38″ forms a junction between each of the feed channels 40′ and 40″ respectively and the outlet channel 26 located in register with the center of the flow reducer member 30. The arrows represent the flow direction of the liquid.

As can be seen in FIG. 5, each channel 38′, 38″ comprises a plurality of non-aligned segments. More precisely, each liquid deflector channel 38′, 38″ comprises five segments of which one is a common segment 38″′. The first and second segments form an angle of about 45°, the second and third segments also form an angle of about 45°, the third and fourth segments form an angle of about 90°, and the fourth and fifth segments form an angle of about 60°.

By means of the liquid deflector channels 38′, 38″, points are created within the liquid at which the flow of the liquid is disturbed, thereby making it possible to increase the head losses of the flow.

Naturally, the channels may include more or fewer segments, some other number of channels, and/or different angles between the segments.

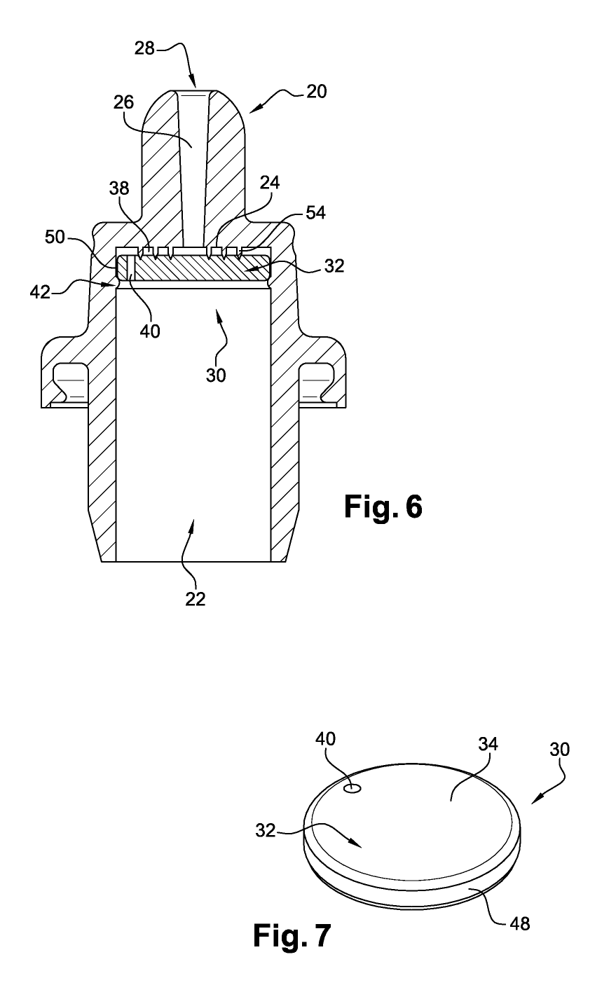

FIGS. 6 and 7 show a fourth embodiment in which the elements similar to the elements of the other embodiments are identified by the same numerical references.

This embodiment differs from the above embodiments in that the end wall 24 of the dispenser endpiece 20 includes portions in relief 54 that are molded integrally with the endpiece, and the flow reducer member 30 includes a base 32 having the shape of a disk.

In this embodiment and by way of example, the endpiece 20 includes a circular bead 42 that makes it possible to press the member 30 against the end wall 24 of the endpiece including the portions in relief 56, and to fasten the member 30 in this position by snap-fastening. Thus, the portions in relief 56 are pressed against the transverse surface 34 of the flow reducer member 30, and they deform the transverse surface 34 of the flow reducer member a little in compression so as to guarantee sealing. The portions in relief 56 co-operate with the surface 34 to define the liquid deflector channel 38.

It should be observed that the flow reducer member 30 is a part that is very simple to make, namely a disk including a feed channel 40 passing therethrough.

Furthermore, in this embodiment, as in the other embodiments, the flow reducer member 30 may advantageously be made out of a flexible material, e.g. an elastomer material. Thus, the reducer member 30 adapts to any dimensional clearances and/or surface irregularities of the endpiece 20 that might be present, thereby making it possible to improve sealing between the flow reducer member 30 and the endpiece 20.

Finally, it should be observed that the invention is not limited to the embodiments described above. In particular, the liquid deflector channel 38 may be of a shape other than the shapes described above, the closure wall 44 may be combined with channel shapes other than the spiral channel 38, and the method of fastening the flow reducer member 30 is not limited to the sole embodiment of the member that is described above. In one example among many possibilities, a flow reducer member 30 including a spiral channel 38 may be fastened on the endpiece 20 by snap-fastening and need not include a closure wall.

1. A liquid dispenser device comprising:
a dispenser endpiece including a cavity having an end wall from which there extends a longitudinal liquid outlet channel; and
a flow reducer member that is fitted in the cavity of the endpiece, said flow reducer member including a transverse surface that co-operates with the end wall of the endpiece to define a liquid deflector channel that extends in a transverse plane, the deflector channel being non-rectilinear, and an essentially longitudinal feed channel through which liquid flows, and in which the liquid deflector channel forms a junction between the outlet channel and the feed channel.

2. A device according to claim 1, wherein the end wall of the endpiece includes a transverse surface that is substantially plane, and the transverse surface of the flow reducer member includes portions in relief that co-operate with the end wall of the endpiece to define the liquid deflector channel.

3. A device according to claim 2, wherein the flow reducer member includes a base having a support function, carrying the portions in relief, and having a height in the longitudinal direction that is greater than the height of the portions in relief.

4. A device according to claim 1, wherein the transverse surface of the flow reducer member is substantially plane, and the end wall of the endpiece includes portions in relief that co-operate with the transverse surface of the flow reducer member to define the liquid deflector channel.

5. A device according to claim 4, wherein the feed channel is defined entirely by the flow reducer member.

6. A device according to claim 1, wherein the flow reducer member is pressed against the end wall of the endpiece in the longitudinal direction.

7. A device according to claim 1, comprising only two parts: the dispenser endpiece and the flow reducer member.

8. A device according to claim 1, wherein the flow reducer member includes a closure wall for closing the outlet channel, which closure wall is elastically movable between a rest configuration in which liquid can pass, and a deformed configuration in which the wall is pressed against the outlet channel so as to close it, at least in part.

9. A device according to claim 8, wherein the closure wall is connected to a base of the flow reducer member via a deformable wall, the deformable wall presenting a thickness that is small relative to the thickness of the base.

10. A device according to claim 1, wherein the flow reducer member is made out of a flexible material.

11. A device according to claim 1, wherein the flow reducer member is non-porous.

12. A device according to claim 6, wherein the flow reducer member fastened against the end wall by one of snap-fastening, clamping, or ultrasonic welding.

13. A device according to claim 10, wherein the flexible material is an elastomer material.
